(19) United States
(12) Patent Application Publication
(10) Pub. No.: US 2008/0229543 A1
(43) Pub. Date: Sep. 25, 2008

(54) Control Valve For Door Closer

(75) Inventor: Harri Juntunen, Joensuu (FI)

Correspondence Address: SMITH-HILL AND BEDELL, P.C., 16100 NW CORNELL ROAD, SUITE 220, BEAVERTON, OR, 97006, US

(73) Assignee: ABLOY OY

(21) Appl. No.: 10/598,728

(22) PCT Filed: Mar. 2, 2005
(86) PCT No.: PCT/FI05/50056

§ 371 Date: Sep. 8, 2006

(30) Foreign Application Priority Data
Mar. 10, 2004 (FI) 20040381

(51) Int. Cl. E05F 5/10

(52) U.S. Cl. 16/84

(57) ABSTRACT

The invention relates to door closers, particularly a door closer control device that regulates the flow of a pressure medium controlling the function of a door closer. A control device according to the invention includes a support part with a collar that serves as a second support for the control device on the door closer body in addition to the support in the guiding part. This second support holds the control device in place within the pressure medium flow without any rocking or swaying movement, which would hamper the door closing speed.

### FIELD OF TECHNOLOGY

The invention relates to door closers, particularly a door closer control device that regulates the flow of a pressure medium controlling the function of a door closer. Furthermore, the invention relates to the pressure medium flow system of a door closer.

### PRIOR ART

The purpose of a door closer is to close a door after being opened, eliminating the need to separately close it. FIG. 1 illustrates an example of a door closer 1. A shaft 3 is fitted to the door closer body, and a lever arm 2 is attached to the shaft. The other end of the lever arm can be fitted to the door. There is a spring and a piston inside the door closer. The piston is connected to the shaft. When the door is opened, the lever arm turns the shaft, which moves the piston. The moving piston compresses the spring. Once the door has been opened, the spring imposes a pushing force on the piston, which turns the shaft. The turning motion of the shaft moves the lever arm to close the door.

FIG. 2 is a more detailed illustration of a prior art door closer structure. To make the door closer function smooth, a pressure medium flowing from one side of the piston to another is used in door closers. The flow of the pressure medium affects the speed of the door closing. The pressure medium is generally oil suitable for the purpose. FIG. 2 does not show the door closer piston but the channel 23 in the door closer body 28, through which the oil can flow to the opposite side of the piston. In this embodiment, the oil flow is restricted by two control valves 21, 22. The purpose of the first valve 21 is to control the speed of closing at door angles from 180° to 10°. The purpose of the second valve 22 is to control the speed of closing at door angles from 10° to 0°. The figure also shows the channels 24, 25, 26, 27 to the cylinder where the piston is located.

In the following, the situation where the door is closing is examined by referring to FIG. 2. First, the piston, which is being moved by the spring force, tries to move the oil in the cylinder to the opposite side of the piston through the channels 26, 23 and 24. The dashed line 29 illustrates this flow. The first control device 21 sets an appropriate restriction for the flow at larger door angles. Once the door reaches an angle of 10 degrees, the piston has moved enough to close the channel 26 in the cylinder. Correspondingly, the channels 27 and 25 are open when the piston no longer prevents flow in the cylinder. At this stage, the oil tries to flow to the other side of the piston through the channels 27, 23 and 25. The other dashed line 210 illustrates this flow. The second control device 22 sets an appropriate restriction for this flow. Because the piston moving in the cylinder does not make up a completely tight surface against the cylinder wall, by-pass leakage occurs in the channels at a certain phase of the piston movement. At this stage, part of the oil flows to the other side of the piston through the channels 26, 23 and 25. The line 211 illustrates this flow.

FIG. 3 is a more detailed illustration of a particular embodiment of the control device 3 1, also known as the control valve, which is used to restrict oil flow in the channels of the door closer. The basic form of the control valve is cylindrical, and it comprises two main parts: a guiding part 32 and a control part 35. The guiding part is fitted with a thread fillet 33 by which the control valve can be supported on the door closer body 28 (FIG. 2). There is a bevelling 36 in the free end of the control part, allowing the flow of the pressure medium to bypass the control valve in the door closer channel 23. The control valve can be moved in the axial direction by turning it by the end of the guiding part 37 (using an Allen wrench, for example, if a hex socket is formed at the end), making the control part and its bevelling restrict the flow in the channel 23 to the desired extent. In other words, the control valve is used to adjust the cross-sectional area of the flow in the channel at the valve position. It can be noted that if the control part had no bevelling, the regulating properties of the control valve would be significantly more limited.

The control part 35 and the guiding part 32 can be made of different materials. The use of plastic as a control part material is well known. In the example of FIG. 3, a control part of a different material is fitted to a fastening bracket 34 in the guiding part.

In publication AT 293218, a control screw is described in a door closer, in which screw a tap exists on the bezel end side, which purpose is to provide a certain kind of support. The screw is made of one material, i.e. hard metal. However, margin must be left between the support and the body of the door closer so that the screw could be installed in position.

The problem with prior art control devices or control valves is that the control valve tends to rock and sway in the pressure medium flow. This causes jerking in the door closing motion and may even momentarily stop it. The rocking and swaying movement is a particular problem at higher oil pressures and embodiments where the control part is of a resilient material such as plastic.

The purpose of the invention is to eliminate the problem of uneven closing mentioned in the above. The purpose can be achieved by the means presented in the claims.

### SHORT DESCRIPTION OF INVENTION

A control device according to the invention includes a support part at the control part end of the control device, after the bevelling when viewed from the direction of the guiding part.

The collar that can be placed around the support part and is preferably made of a resilient material provides a second support for the control device on the door closer body in addition to the support in the guiding part. So, the collar comprises a supporting surface that can be placed against the body of the control device. This second support holds the control device in place within the pressure medium flow without any rocking or swaying movement, which would hamper the door closing speed. The invention also prevents axial movement of the control device.

Thus the control device according to the invention, intended for regulating the pressure medium flow that controls the function of a door closer utilising a pressure medium, comprises a guiding part of the control device, which can be supported on the door closer body using a thread fillet, a control part with a bevelling for regulating the pressure medium flow, and a support part that can be fitted with a collar at the bevelled end of the control part for supporting the control device on the door closer body and holding the control device in position in the pressure medium flow through the collar. The collar comprises a supporting surface that can be placed against the body of the control device.

In an embodiment of the invention, the collar comprises at least one chase to reduce its thickness at a certain part of the collar. The collar can preferably be preinstalled in the door closer body. When the control device is installed in the door closer, the support part of the control device becomes seated in the collar. The collar is preferably made of a resilient material such as plastic.

Furthermore, the by-pass leakage of the pressure medium that hampers the door closing speed is eliminated by using two different channels that provide a route for the pressure medium to the opposite side of the piston. The first channel is for greater door angles and the second channel is for small angles.

### LIST OF FIGURES

In the following, the invention is described in more detail by reference to the enclosed drawings, where

FIG. 1 illustrates an example of a prior art door closer,

FIG. 2 illustrates an example of the structure of a prior art door closer,

FIG. 3 illustrates a prior art embodiment of a control device,

FIG. 4 illustrates an embodiment of a control device according to the invention,

FIG. 5 illustrates a collar that can be applied to the embodiment of FIG. 4,

FIG. 6 illustrates an installation example utilising the embodiment of FIG. 4, and a dual-channel system.

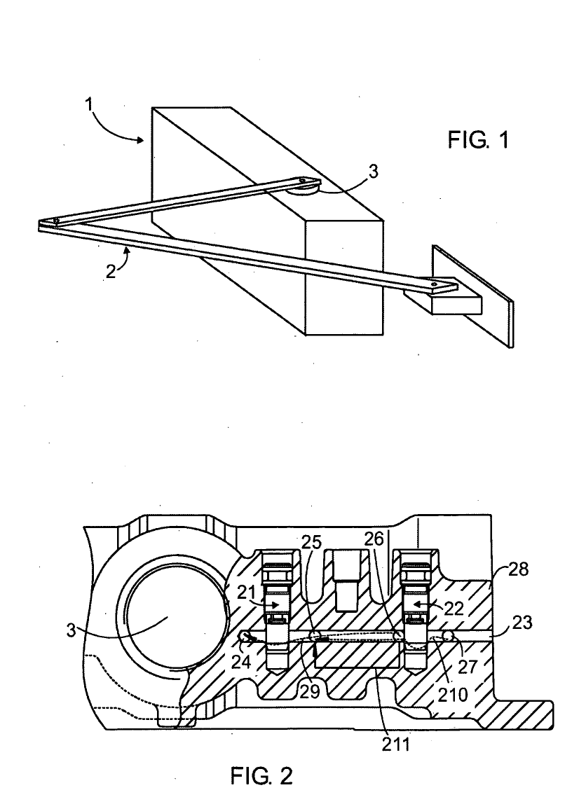

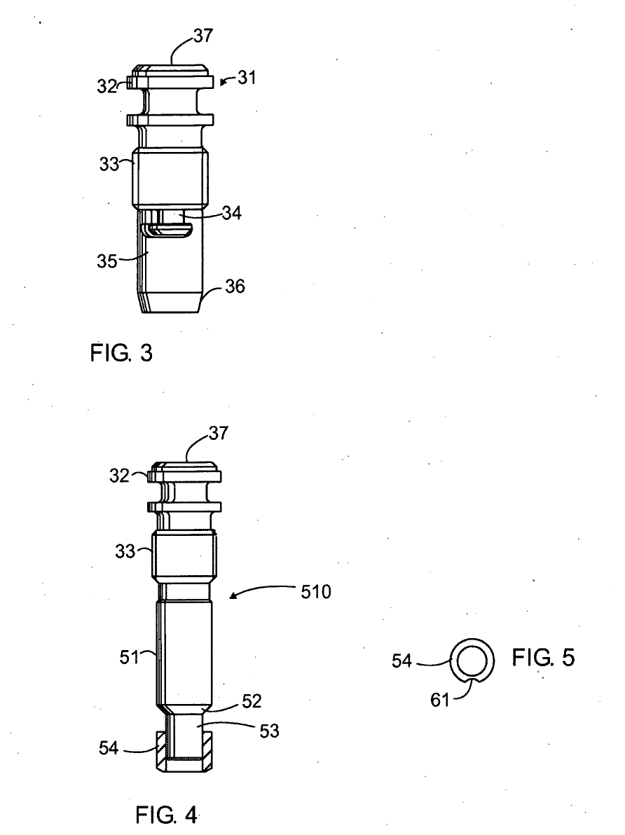

### DESCRIPTION OF THE INVENTION

FIG. 4 illustrates an embodiment of the invention 510. Similar to prior art control devices, the control device 510 according to the invention has a cylindrical basic form and comprises a guiding part 32 and a control part 51. The guiding part is fitted with a thread fillet 33 by which the control valve can be supported on the door closer body 28 (FIG. 2). There is a bevelling 52 in the free end of the control part, allowing the flow of the pressure medium to bypass the control valve in the door closer channel 23. The control valve can be moved in the axial direction by turning it in relation to the door closer body by the end of the guiding part 37, making the control part and its bevelling restrict the flow in the channel 23; thus, the control device restricts the cross-sectional area of the flow in the channel at the control device position. The bevelled end of the control part contains a support part 53, around which exists a collar 54 that provides a supporting surface against the door closer body. The supporting surface rests on the door closer body when the control device is installed in a door closer.

The control device according to the invention does not rock or sway in the pressure medium flow. In order to achieve good controllability, the clearance between the control device and the door closer body must be small. A large clearance increases the swaying motion of the control device. The control valve and the valve housings may not have any angle of taper. It is difficult and expensive to manufacture control valves and valve housings with small tolerances. Due to this, it is preferable to use a resilient material that allows larger tolerances. Sufficient compression of the collar of the support part against the body prevents unwanted axial movement.

The invention also prevents axial movement of the control device. It is a fairly common problem that the control valve tends to unscrew due to the effect of the oil and its pressure. Thus the control valve can start to unscrew over time, making the twisting gradually stronger and putting the control valve out of adjustment. The invention intends to hold the control device in place in all directions.

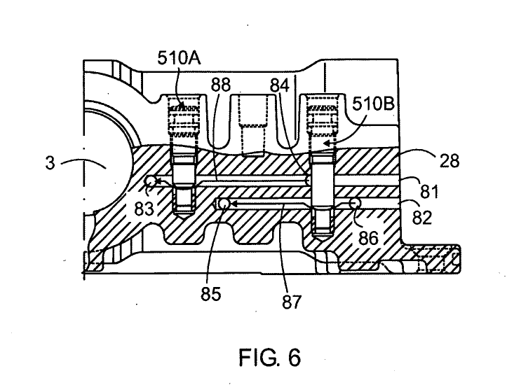

As described in the above, the collar 54 is preferably made of a resilient material, such as plastic or soft metal (including alloys). The collar can be placed in the door closer before installing the control device, after which the control screw is placed inside the collar by pulling with a thread fillet, for example. Another option is to place the collar in the control device first, after which the control device with the collar is placed in the door closer. It should be noted that the collar's pressure against the door closer body prevents the control device from unscrewing. The collar may also have a chase 61 at a certain location to reduce the thickness of the collar as illustrated in FIG. 6, for example. The chase improves the resilience and consequently the installability of the collar. The collar may also have several chases. The advantage of using a resilient material is that the control device can be fitted in the door closer body without any clearance. A soft material such as plastic allows larger tolerances than conventional metals (such as aluminium and/or brass).

In addition to the examples described in the above, a control device according to the invention can also be implemented using other embodiments. For example, the control device end 37 may have a hex socket, a crosshead socket or a simple groove for turning the control device. However, a control device according to the invention always includes a guiding part, a control part and a support part with a collar. The support part can be metal, and the same is true for the control part. The guiding part is preferably metal. The different parts may be manufactured of a common solid part, such as brass, or they can be manufactured separately and assembled together later. A preferred embodiment is one where the guiding part, control part and support part are manufactured of the same solid metal, and the collar is plastic.

As previously already referred to FIG. 2, oil by-pass leakage occurs in channel 23 through the channels 26 and 25. In order to solve the by-pass leakage problem, separate channels are formed for both control devices 510. FIG. 6 illustrates an installation example utilising the embodiment of FIG. 4, where the door closer contains a dual-channel system. The first valve 510A regulates the closing speed at door angles from 180° to 10°. The pressure medium flows through the channels 84, 81 and 83 to the opposite side of the piston. The arrow 88 illustrates this flow. The purpose of the second valve 510B is to control the speed of closing at door angles from 10° to 0°. The pressure medium flows through the channels 86, 82 and 85 to the opposite side of the piston. The arrow 87 illustrates this flow. The dual-channel system makes it possible to eliminate the adverse by-pass leakage.

The channels 81 and 82 in FIG. 6 are preferably on top of each other in the same plane. Thus the control valves 510A and 510B are in the same plane with the channels as well. This solution is preferred because it saves space in the door closer body. Due to this, one of the channels (in this case channel 81) is routed via both control valves. It should be noted that in the arrangement according to FIG. 8, the control valve 510B does not encumber the flow 88 controlled by the control valve 510A (such as by-pass leakage to channel 82). If the channels 81 and 82 were on different planes, the door closer body would be thicker (in the direction perpendicular to the plane of FIG. 6) and more body material would be required for manufacturing.

It is evident from the above that the invention is not limited to the embodiments described in this text but can be implemented in many other different embodiments within the scope of the inventive idea.

1-4. (canceled)

5. A control device for regulating the pressure medium flow in a door closer utilising a pressure medium, including a guiding part of the control device that can be supported on the door closer body using a thread fillet, and a control part with a bevelling, which allows the control device to be moved in its axial direct on by turning the control device supported on the door closer body in relation to the body in order to result in the desired restriction of the pressure medium flow by the control part and its bevelling, wherein the control device comprises, at the bevelled end of the control part, a support part and a collar that is a resilient material and can be placed around the support part for providing a supporting surface that can be place against the door closer body, which control part and collar are used for supporting the control device on the door closer body and holding the control device in place in the pressure medium flow, which support is based on compression of the collar.

6. A device according to claim 5, wherein the collar comprises at least one chase to reduce its thickness at a certain part of the collar.

7. A device according to claim 5, wherein the collar can be preinstalled in the door closer body so that when the control device is installed in the door closer, the support part of the control device becomes seated in the collar.

8. A device according to claim 5, wherein the collar is plastic.
